(19) United States
(12) Patent Application Publication
(10) Pub. No.: US 2015/0013556 A1
(43) Pub. Date: Jan. 15, 2015

(54) Web Break Analysis System and Method and Corresponding Printing Press

(71) Applicant: GOSS CONTIWEB B.V., Boxmeer (NL)

(72) Inventor: Paul SLAATS, Best (NL)

(21) Appl. No.: 14/331,861

(22) Filed: Jul. 15, 2014

(30) Foreign Application Priority Data
Jul. 15, 2013 (EP) 13176492.0

(51) Int. Cl. B41F 33/18; G06F 17/18; B41F 5/04

(52) U.S. Cl. CPC B41F 33/18; B41F 5/04; G06F 17/18
USPC 101/219; 702/35

(57) ABSTRACT

A system for analyzing web breaks in a printing press is provided. The system includes sensing devices for monitoring the web, the printing press and detecting a web break. The system includes a database with predetermined web break causes, a real cause probability calculation algorithm for calculating the probability that the corresponding predetermined web break cause is the real cause of a detected web break as a function of the outputs of the sensing devices and a real web break cause determining processor for executing each real cause probability calculation algorithm. The predetermined web break causes are ranked according to the calculated real cause probabilities, and the web break cause among the predetermined web break causes with the highest real cause probability as the cause for the detected web break is identified. A web printing press and method are also provided.

The present invention relates to a system for analyzing web breaks in a web-fed printing press, comprising a plurality of sensing devices adapted to monitor properties of the web and operating parameters of the printing press, as well as to detect a web break, and to a method for analyzing web breaks in a web-fed printing press.

### BACKGROUND

Such a system and method are sold by the company Procemex Oy Ltd of Finland under the trade name “PROCEMEX-PRINT”. A brochure describing said system and method can be obtained from Procemex.

This known solution uses on press mounted high speed video cameras that continuously film the running web. In case of a web break, the cause of the break is determined by a human press operator reviewing the video data provided by the video cameras.

### BRIEF SUMMARY OF THE INVENTION

However, manually reconstructing the likely cause of a web break by watching video data from numerous video cameras is tedious, time-consuming and error prone.

Furthermore, this known solution does not allow identifying web break causes that are not due to faults in the paper web.

An object of the present invention provides a web break analysis system and method that allows for easier and quicker determination of the likely cause of a web break.

The present invention provides a system for analyzing web breaks in a web-fed printing press, comprising a plurality of sensing devices adapted to monitor properties of the web and operating parameters of the printing press, as well as to detect a web break, characterized by:

1) a database with a list of predetermined web break causes;

2) for each of the predetermined web break causes, a real cause probability calculation algorithm for calculating the probability that the corresponding predetermined web break cause is the real cause of a detected web break at least partially as a function of outputs delivered by said sensing devices, and

3) a real web break cause determining processor adapted to, upon detection of a web break:

a) execute each real cause probability calculation algorithm;

b) rank the predetermined web break causes according to their calculated real cause probabilities; and

c) identify the one or several web break causes amongst the predetermined web break causes with the highest real cause probability as the most likely cause for said detected web break.

The present invention also provides a method including the steps of:

1) providing a list of predetermined web break causes;

2) monitoring web properties and printing press operating parameters in said web fed printing press;

3) detecting a web break in said web-fed printing press;

4) calculating for each of the predetermined web break causes the probability that the corresponding predetermined web break cause is the real cause of the detected web break at least partially based on the results of said monitoring;

5) ranking the predetermined web break causes according to their calculated real cause probabilities; and

6) identifying the one or several web break causes among the predetermined web break causes with the highest real cause probability as the most likely cause for said detected web break.

According to preferred embodiments, the system of the present invention may include one or several of the following features, taken alone or in all technically possible combinations:

each of said sensing devices includes one or more of the following: web tension sensor, web break position detecting sensor, web break time detecting sensor, web edge position sensor, web speed sensor, web fault detecting camera, printing press process state detector; and

the system is adapted to allow its user to modify the list of predetermined web break causes in said database.

Similarly, the method of the present invention may include one or more of the following features:

the monitoring and detecting includes the measurement of one or more of the following quantities: time of web break, location of web break in the printing press, web tension, web edge position, web faults, web speed, process state of the printing press;

said detecting includes determining the time of said web break based on the detection of a loss of the web tension;

said detecting includes determining the location of said web break based on the detection of the web edges;

said calculating is also based on manual input provided by a printing press operator and/or on input from web break detection sensors; and

the method is carried out using the system as described above.

The present invention also provides a web-fed printing press comprising a splicer, at least one printing unit, a folder and the system in accordance with the present invention, wherein said system includes one or more of the following:

1) a first web tension sensor inside the splicer and/or a second web tension sensor at the splicer exit;

2) one or more web break sensors between the printing units and/or inside the folder;

3) at least one camera, in particular a high resolution camera, inside the splicer for detecting web faults;

The printing press may be a heat set printing press, preferably including a dryer and/or a chiller.

The system of the printing press may also include one or more of the following:

1) a third web tension sensor at the dryer exit, and/or a fourth web tension sensor at the chiller exit;

2) a left web edge position sensor and/or a right web edge position sensor inside the chiller;

3) one or more web edge sensors in the splicer;

4) one or more web edges sensors in front of the dryer.

### BRIEF DESCRIPTION OF THE DRAWINGS

The invention will be better understood when reading the following description of non limiting examples of the present invention, with reference to the accompanying drawings, in which:

FIG. 1 is a block diagram of the web break analysis system according to the present invention;

FIG. 2 shows a preferred embodiment of the sensors in the system of a web-fed printing press according to the present invention; and

FIG. 3 is a graph showing sensor readings for a web break caused by damage on the right side of a paper reel.

### DETAILED DESCRIPTION

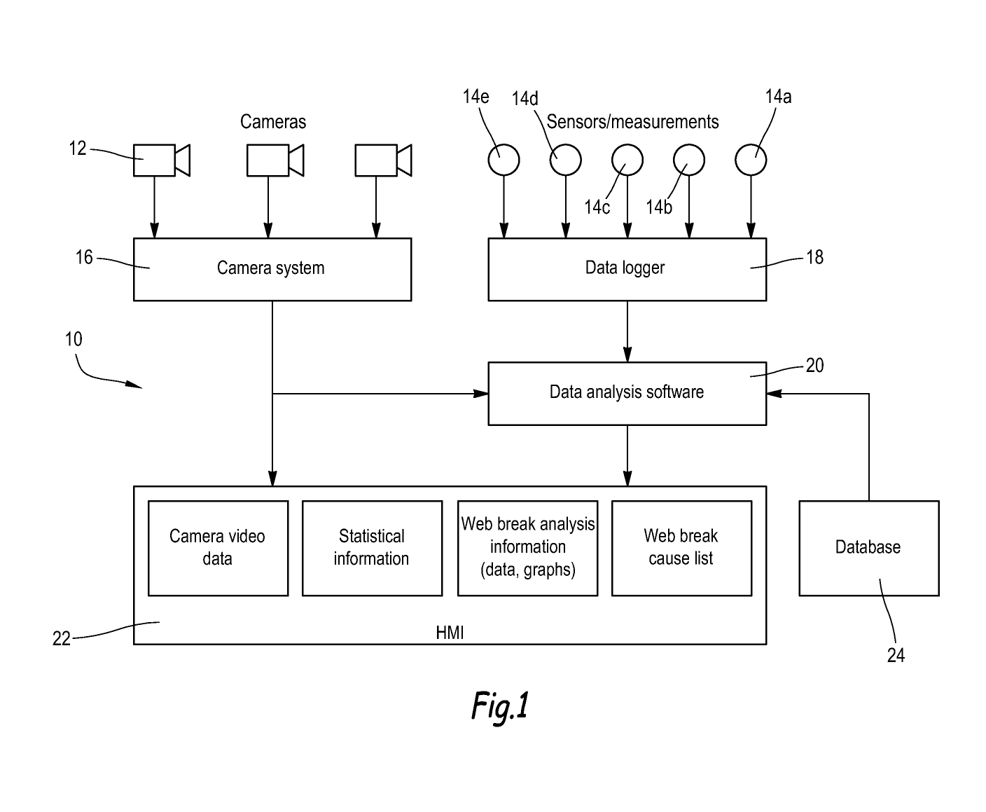

With reference to FIG. 1, there is shown a web break analysis system 10. System 10 includes a set of sensing devices 12, 14, several data processors 16 to 20, a human/machine interface (HMI) 22, and a database 24. In the shown exemplary embodiment, the sensing devices comprise high resolution cameras 12 (for detecting paper web faults, a web tension sensor 14a, a web break sensor 14b, a left web edge position sensor 14c, a right web edge position sensor 14d, and a web speed sensor 14e.

In the present context, a “high resolution” camera is a camera able to resolve paper defects down to a size of 1×1 mm on a running paper web and this preferably up to a paper web speed of 20 m/s over the full width of the paper web.

In alternative embodiments, the sensing devices may include additional or different sensors that can be useful for web break analysis. For example, web break analysis system 10 may also sense various common printing press operating parameters such as the current process state of the printing press (emergency stop, safe stop, impression on/off, washing on/off, splicing active, etc . . . ) with a printing press process state detector.

The printing press process state detector may include proximity switches, limit switches and/or force sensors installed on the printing press. The printing press process state detector may also rely on outputs from the printing press, splicer and/or dryer control system software.

The sensing devices 12, 14 are adapted to be installed at desired locations on a web-fed printing press.

High resolution cameras 12 are connected to a camera system 16, namely a video signal processor. Sensors 14 are connected to a data logger 18 that collects and temporarily stores the data output from sensors 14. Data logger 18 is connected to a real web break cause determining processor 20. Real web break cause determining processor 20 is fitted with a data analysis software.

Database 24 is connected to real web break cause determining processor 20, allowing web break cause determining processor 20 to access database 24. Database 24 contains a list of predetermined web break causes. A predetermined web break cause is an event, which, by experience, is known to potentially result in a web break during operation of a web-fed printing press. Examples of such known web break causes are a hole or wrinkles in the paper web, or a bad splice in the paper web.

The data analysis software of real web break cause determining processor 20 includes a real cause probability calculation algorithm for each of the predetermined web break causes in the database list.

Camera system 16 and real web break cause determining processor 20 are both connected to a human-machine interface (HMI) 22. Typically, the HMI 22 includes one or more screens and some input means for the printing press operator. As shown in FIG. 1, the HMI 22 may be adapted to play back the video data captured by cameras 12, to provide statistical information on the monitored paper web, to display results of an analysis of a web break, and to provide a list of the most likely causes of a current web break.

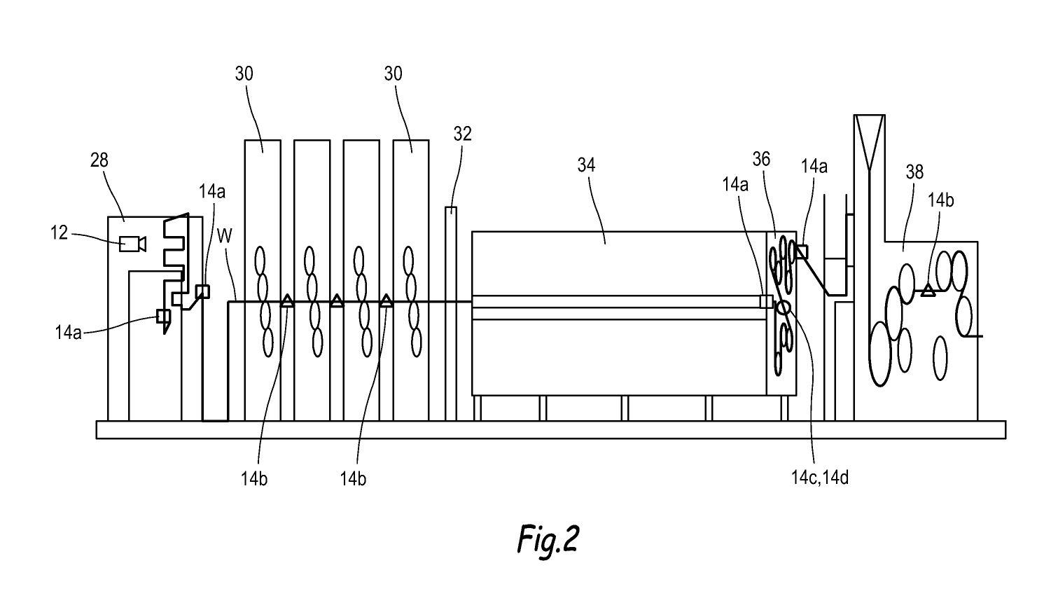

FIG. 2 shows a web-fed heatset offset printing press 26 on which the inventive web break analysis system 10 may be installed. Web break analysis system 10 is a standalone system and can be installed as an add-on to any web-fed printing press. In particular, web break analysis system 10 can be retro-fitted to already existing and running web-fed printing presses.

Web-fed offset printing press 26 comprises a splicer 28, at least one, and for example four printing units 30, a web catcher 32, a dryer 34, a chiller 36, and a folder 38. The paper web running through printing press 26 is referenced by the letter W.

The cameras 12 and sensors 14 of web break analysis system 10 can be fitted on printing press 26 as follows:

one or more cameras 12 (depending on the width of the paper web W) are installed inside splicer 28 and are adapted to monitor the unprinted paper web W for paper faults such as holes or wrinkles;

a first web tension sensor 14a is located inside splicer 28, a second web tension sensor 14a is located at the splicer exit, a third web tension sensor 14a is arranged at the dryer exit, and a fourth web tension sensor 14a is located at the chiller exit;

a left web edge position sensor 14c and a right web edge position sensor 14d are mounted inside chiller 36; and

web break sensors 14b are located each time between two printing units 30, and additional web break sensors are mounted inside folder 38.

Optionally, web edge position sensors are also installed in the splicer 28 and are part of the web break analysis system 10.

The following is an explanation of how the web break analysis system 10 is capable of identifying the true cause of a detected web break in accordance with the present invention.

### Example 1

### Web Break Caused by Damage on the Right Side of the Paper Reel

A web-fed printing press is fitted with the inventive web break analysis system 10. In this example, web break analysis system 10 includes a web speed sensor, a right web edge position sensor and a left web edge position sensor inside the printing press' splicer, as well as several web break time and position sensors arranged along the printing press.

A paper web with a tear on its right edge is unwound from a reel and fed into the printing press. Somewhere inside the printing press 26, the tear propagates transversely through the entire paper web, resulting in a web break.

Web break analysis system 10 detects the web break and calculates for each of the known web break causes mentioned in database 24 its “real cause probability”, i.e. the probability that the corresponding web break cause is the true cause of the web break. The probability calculations are done using the signals received from the various sensors of web break analysis system 10.

Web break analysis system 10 will also determine a real cause probability for the cause “paper fault” stored in database 24. More precisely, web break analysis system 10 will compare the position of the web break in the printing press provided by one of the web break position sensors with the position of the tear in the printing press at the time of web break. If the two positions match, then web break analysis system 10 will assign a high real cause probability (e.g. 80%) to the predetermined web break cause “paper fault”. If the positions are substantially different, then web break analysis system 10 will assign a low real cause probability (e.g. 10%) to the predetermined web break cause “paper fault”.

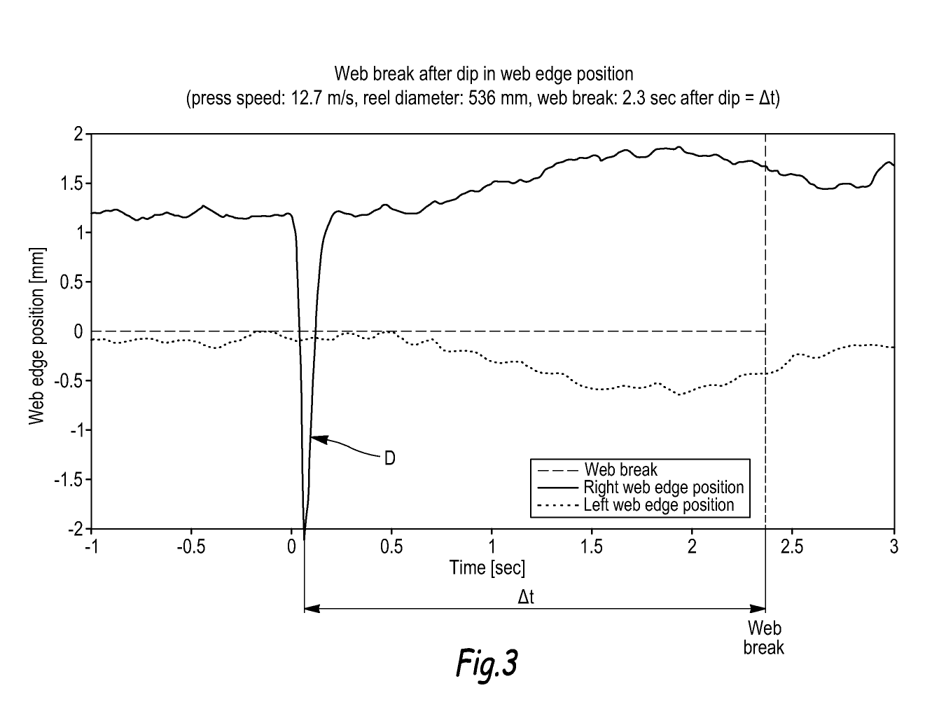

FIG. 3 is a graph showing the outputs of the right web edge position sensor (solid line), of the left web edge position sensor (dotted line), and of the web break time sensor (dashed line) as a function of time. The dip D in the output of the right web edge position sensor corresponds to the tear in the paper web.

By measuring the time Δt between the detection of the tear at the right web edge position sensor (i.e. at the splicer) and the web break, and by knowing the web speed from the web speed sensor, web break analysis system 10 can calculate the position of the tear at the time of web break.

### Example 2

### Web Break Caused by a Bad Splice

Again, a web-fed printing press is fitted with the inventive web break analysis system 10. This time, the splicer of the printing press performs a bad splice that travels through the printing press and causes a web break.

Web break analysis system 10 detects the web break at a certain location in the printing press. It then calculates for each of the known web break causes mentioned in database 24 its real cause probability.

Web break analysis system 10 will also determine a real cause probability for the cause “bad splice” stored in database 24. More precisely, web break analysis system 10 compares the break location with the location of the splice. If they are the same, it is very likely that the splice has been made badly thus causing the web to break. If the splice is around the break location (a few meters before or after), there still is a chance that it was the cause of the web break, but not as high when the locations match. If the splice is more meters away from the break location, the chance that it caused the break is almost 0%.

Preferably, by also considering the process state of the printing press at the moment of the break, web break analysis system 10 can further improve the real cause probability calculation. For example, if the printing press was washing during splicing, the probability that the web break was caused by a bad splice is higher than if the printing press was printing during splicing.

Web break analysis system 10 can improve the real cause probability calculation even further by taking into account the web speed or web acceleration at the time of splicing or other web-related process properties. If the web was accelerating or decelerating during the splice, the real cause probability for the predetermined web break cause “bad splice” is higher than if the web speed was constant during the splice.

Tables 1-3 are simplified examples of real cause probability calculation matrices that might be used by web break analysis system 10 for calculating the real cause probability P of the predetermined web break cause “bad splice”.

TABLE 1

| Base probability (B) in % | | | | |
|---|---|---|---|---|
| Splice location at time | Break location | | | |
| of web break | Splicer | Print unit | Dryer | Folder |
| Splicer | 80 | 40 | 0 | 0 |
| Print unit | 40 | 80 | 40 | 0 |
| Dryer | 0 | 40 | 80 | 40 |
| Folder | 0 | 0 | 40 | 80 |

TABLE 2

| Process state of printing | |
|---|---|
| press at time of web break | 1^{st} probability multiplier (M1, from 0-100) |
| Washing | 80 |
| Printing | 50 |

TABLE 3

| Web speed during splicing | 2^{nd} probability multiplier (M2, from 0-100) |
|---|---|
| Increasing | 80 |
| Constant | 50 |
| Decreasing | 80 |

Using its sensor readings, web break analysis system 10 can look up the base probability B, the 1^{st} probability multiplier M1, and the second probability multiplier M2 in tables 1 to 3 for the predetermined web break cause “bad splice”. A corresponding real cause probability score S can then be calculated with the following equation:

S=B×(1+M1/100)×(1+M2/100)

For example, if the sensors of web break analysis system 10 indicate that the web break occurred in the dryer and the location of the splice at the time of web break was also in the dryer, then web break analysis system sets B=80, according to table 1. If, at the time of web break, the printing press was printing, then web break analysis system 10 sets M1=50, according to table 2. Finally, if, during a web break, the speed of the web was increasing, then web break analysis system sets M2=80, according to table 3. Web break analysis system 10 then obtains S=80×1.5×1.8=216.

A real cause probability score Si is determined for each of a total t of possible predetermined web break causes Ci. The real cause probability Pi for each possible predetermined web break cause Ci is then calculated with the following equation:

Pᵢ=Sᵢ/Σₙ₌₁^{n=t}Sₙ

Continuing the example, we assume that there is only one other possible web break cause (e.g. “hole in paper web”) with a corresponding M=80. Hence, web break analysis system 10 determines P1=216/(216+80)=0.73 as the value for the real cause probability of the predetermined web break cause “bad splice”. Likewise, web break analysis system 10 determines P2=80/(216+80)=0.27 as the value for the real cause probability of the predetermined web break cause “hole in paper web”.

In a preferred embodiment, web break analysis system 10 may be adapted to allow its user to modify the list of predetermined web break causes in database 24 as well as the base probabilities B and the probability multipliers M.

Preferably, web break analysis system 10 is also capable of self-learning, e.g. by automatically optimizing the base probabilities B and the probability multipliers M based on data collected during previous web breaks. Self-learning may be implemented with fuzzy-logic and/or by using statistical and logged data of previous web breaks.

In a further preferred embodiment, web break analysis system 10 provides information about the quality of the paper web's paper. This can e.g. be achieved by monitoring the paper web images delivered by cameras 12 for paper defects and calculating for example the percentage of holes, scratches etc. in the paper web per square meter.

Also, web break analysis system 10 may detect recurring web damages (e.g. a tear on the edge of the paper) by using sensors and/or the cameras 12, and may assign these damages to certain causes based on the rhythm of the recurrence.

Furthermore, web break analysis system 10 may generate a web break report that contains all relevant web break information including paper defect images (if the break is caused by a paper defect). Such a report can then be used as evidence for a bad paper claim against a paper web supplier.

Web break analysis system 10 may also determine set points for various operating parameters of the printing press in order to reduce the risk of web breaks. For example, web break analysis system 10 may determine an optimal web tension for a certain paper or production type. The set points may be automatically determined based on historical analysis of web breaks.

In addition, information from the web break analysis system 10 can be used to make the printing press more productive.

The present invention may also include the following general aspects:

The present invention applies to any web fed printing press, in particular a heat-set web fed printing press with dryer and chiller, or a cold-set web fed printing press without any dryer or chiller. It applies also to digital and/or offset print units.

While the algorithm has been described being implemented using software, it can also be implemented using conventional means and/or hard-wired using an integrated circuit.

What is claimed is:

1. A system for analyzing web breaks in a web-fed printing press including a plurality of sensing devices adapted to monitor properties of a web and operating parameters of the printing press, as well as to detect a web break, the system comprising;
a database with a list of predetermined web break causes;
for each of the predetermined web break causes, a real cause probability calculation algorithm for calculating a probability that the corresponding predetermined web break cause is a real cause of a detected web break at least partially as a function of outputs delivered by the sensing devices; and
a real web break cause determining processor adapted to, upon detection of a web break:
a) execute each real cause probability calculation algorithm;
b) rank the predetermined web break causes according to the respective calculated real cause probabilities; and
c) identify the one or several web break causes among the predetermined web break causes with the highest real cause probability as the most likely cause for the detected web break.

2. The system of claim 1, wherein each of the sensing devices includes one or more of the following: web tension sensor, web break position detecting sensor, web break time detecting sensor, web edge position sensor, web speed sensor, web fault detecting device such as a camera and a printing press process state detector.

3. The system of claim 1, wherein the system is adapted to allow a user to modify the list of predetermined web break causes in the database.

4. A web-fed printing press comprising:
a splicer;
at least one printing unit;
a folder; and
the system recited in claim 1, wherein the system includes one or more of the following:
1) a first web tension sensor inside the splicer or a second web tension sensor at the splicer exit;
2) one or more web break sensors between the printing units and/or inside the folder;
3) at least one camera inside the splicer for detecting web faults.

5. The printing press of claim 4, wherein the printing press is a heat set printing press.

6. The printing press of claim 14, wherein the system includes one or more of the following:
a third web tension sensor at a dryer exit, and/or a fourth web tension sensor at a chiller exit;
a left web edge position sensor and/or a right web edge position sensor inside the chiller;
one or more web edge sensors in the splicer;
one or more web edge sensors in front of the dryer.

7. A method for analyzing web breaks in a web-fed printing press, comprising the steps of:
providing a list of predetermined web break causes;
monitoring web properties and printing press operating parameters in said web-fed printing press;
detecting a web break in said web-fed printing press;
calculating for each of the predetermined web break causes the probability that the corresponding predetermined web break cause is a real cause of the detected web break at least partially based on the results of said monitoring;
ranking the predetermined web break causes according to the calculated real cause probabilities; and
identifying one or several web break causes among the predetermined web break causes with the highest real cause probability as the most likely cause for said detected web break.

8. The method of claim 7, wherein said monitoring and detecting includes a measurement of one or more of the following quantities: time of web break, location of web break in the printing press, web tension, web edge position, web faults, web speed and process state of the printing press.

9. The method of claim 7, wherein said detecting includes determining a time of said web break based on a detection of a loss of web tension.

10. The method of claim 7, wherein said detecting includes determining a location of said web break based on a detection of web edges.

11. The method of claim 7, wherein said calculating is based on manual input provided by a printing press operator and/or on input from web break detection sensors.

12. The method of claim 7 carried out using the system of claim 1.

13. The web printing press of claim 4, wherein the at least one camera is a high resolution camera.

14. The web printing press of claim 5, further comprising a dryer and/or a chiller.

15. The method of claim 7, wherein the steps are performed consecutively.
